(19) United States
(12) Patent Application Publication
(10) Pub. No.: US 2020/0159022 A1
(43) Pub. Date: May 21, 2020

(54) METHOD FOR PROVIDING USER-CUSTOMIZED AUGMENTED-REALITY SERVICE AND APPARATUS USING THE SAME

(71) Applicant: Electronics and Telecommunications Research Institute, Daejeon (KR)

(72) Inventors: Hye-Sun PARK, Daejeon (KR); Hyun KANG, Daejeon (KR); Byung-Kuk SEO, Daejeon (KR); Bon-Ki KOO, Daejeon (KR)

(73) Assignee: Electronics and Telecommunications Research Institute, Daejeon (KR)

(21) Appl. No.: 16/664,607

(22) Filed: Oct. 25, 2019

(30) Foreign Application Priority Data
Nov. 21, 2018 (KR) 10-2018-0144524
Mar. 26, 2019 (KR) 10-2019-0034304
Sep. 10, 2019 (KR) 10-2019-0112017

(51) Int. Cl. G02B 27/01; G06T 19/00; G02B 5/30; G02B 27/00; G06F 3/01

(52) U.S. Cl. CPC G02B 27/0172; G06T 19/006; G02B 5/30; G02B 2027/0118; G06F 3/011; G06F 3/017; G02B 2027/014; G02B 27/0093

(57) ABSTRACT

Disclosed herein are a method and apparatus for providing a user-customized augmented-reality service. The method is configured to extract the basic ergonomic information of a user by sensing the body of the user who is using an augmented-reality service, to generate user-customized ergonomic information by modifying the basic ergonomic information of the user based on at least one of misrecognition occurring in predefined basic interaction and user evaluation information, to detect the physical characteristics of the user by comparing the basic ergonomic information of the user with the user-customized ergonomic information, to define user-customized interaction by reflecting the physical characteristics of the user in the predefined basic interaction, to extract the unique characteristics of the user from usage data accumulated through the user-customized interaction, and to update the user-customized interaction so as to match the unique characteristics of the user.

### CROSS REFERENCE TO RELATED APPLICATIONS

This application claims the benefit of Korean Patent Application No. 10-2018-0144524, filed Nov. 21, 2018, No. 10-2019-0034304, filed Mar. 26, 2019, and No. 10-2019-0112017, filed Sep. 10, 2019, which are hereby incorporated by reference in their entireties into this application.

### BACKGROUND OF THE INVENTION

### 1. Technical Field

The present invention relates generally to technology for providing an augmented-reality service, and more particularly to technology for providing an augmented-reality service using ergonomic information pertaining to a user and a user experience in order to provide natural interaction in an augmented-reality environment.

### 2. Description of the Related Art

Recently, a lot of research and development on augmented-reality technology, which overlays virtual information onto the real world so as to be used in various fields, such as the medical field, the advertising field, the education field, various industrial fields, and the like, have been conducted, and efforts to solve issues arising therefrom have been made. Particularly, there are many issues involving existing augmented-reality provision devices, methods for handling such devices (manipulation or interaction), and the quality of augmented-reality information, and these issues make it difficult for users to accept augmented reality.

In order to enable general users to easily and usefully use an augmented-reality service, it is necessary to develop augmented-reality technology and devices based on user experience. For example, it is necessary to apply a user-centered learning method or an intuitive interface to a small and lightweight real-life product, such as glasses, sunglasses, or the like, in order to provide an augmented-reality service. Here, the user-centered learning method or the intuitive interface may be a learning method that anyone who first handles a device can easily learn using a simple motion or pose or an interface through which anyone who first encounters the device quickly grasps how to use the device.

Such an augmented-reality service may be regarded as transcending conventional ways of thinking and as a user experience that a user has never had before. This is because the user controls a remotely located object using his or her arms and hands but there is no actual object to handle, unlike the case in which the user handles an object through an existing multi-touch-based screen. That is, the augmented-reality service is completely new and abstract. The existing method for interaction in augmented reality, for example, the interaction method using a gesture based on the motion extracted from the general movement of a user, requires a user experience (UX) factor based on accumulated data about the unique motion characteristics of the user.

Also, existing devices for providing an augmented-reality service employ a passive training method in which a user is induced or trained to follow directions such that the user becomes accustomed to the use of the device. Such a passive training method makes a user using the device for the first time repeat a gameplay mission using the device, whereby the user may learn to use the device. However, this passive training method is a device-centered approach, and although users follow the directions for use, the users may have different ways of using the device. Therefore, it is necessary to precisely analyze interaction for each user and provide interaction customized to the user. That is, an active and user-centered training method in which a user handles the device in an easier and more convenient way is required.

### Documents of Related Art

(Patent Document 1) Korean Patent No. 10-1671760, published on Oct. 27, 2016 and titled “Set-top box, photographing apparatus for learning and enhancing user interface and user experience by performing context-awareness function based on multi-modal information and method and computer-readable recording medium using the same”.

### SUMMARY OF THE INVENTION

An object of the present invention is to provide an augmented-reality service that provides user-centered information and interaction, thereby providing the user of the augmented-reality service with awareness, usability, and improved user customization.

Another object of the present invention is to provide an augmented-reality service using user experience information such that a user looks more natural and graceful when the user is using the augmented-reality service.

A further object of the present invention is to provide an augmented-reality service in which interaction is provided in accordance with the physical characteristics or motion of a user.

In order to accomplish the above objects, a method for providing a user-customized augmented-reality service according to the present invention may include extracting basic ergonomic information of a user by sensing the body of the user who is using an augmented-reality service; generating user-customized ergonomic information by modifying the basic ergonomic information of the user based on at least one of misrecognition occurring in predefined basic interaction and user evaluation information; detecting the physical characteristics of the user by comparing the basic ergonomic information of the user with the user-customized ergonomic information and defining user-customized interaction by reflecting the physical characteristics of the user in the predefined basic interaction; and extracting the unique characteristics of the user from usage data accumulated through the user-customized interaction and updating the user-customized interaction so as to match the unique characteristics of the user.

Here, the unique characteristics of the user may include at least one of unique motion characteristics of the user and unique information provision characteristics of the user.

Here, generating the user-customized ergonomic information may be configured to generate the user-customized ergonomic information by modifying the basic ergonomic information of the user so as to match at least one of body information and joint rearrangement information input from the user.

Here, the misrecognition may occur in a basic user interface for performing the predefined basic interaction.

Here, the user-customized interaction may be performed through a user-customized interface, which modifies a part of the basic user interface in which the misrecognition occurs so as to match the physical characteristics of the user.

Here, the user-customized ergonomic information may be updated when the user evaluation information is input.

Here, the basic ergonomic information of the user may include at least one of the position of a joint in each body part of the user, the angle thereof, the direction in which the joint moves, and the speed at which the joint moves.

Also, an apparatus for providing a user-customized augmented-reality service according to an embodiment of the present invention may include a processor for extracting basic ergonomic information of a user by sensing the body of the user who is using an augmented-reality service, generating user-customized ergonomic information by modifying the basic ergonomic information of the user based on at least one of misrecognition occurring in predefined basic interaction and user evaluation information, detecting the physical characteristics of the user by comparing the basic ergonomic information of the user with the user-customized ergonomic information, defining user-customized interaction by reflecting the physical characteristics of the user in the predefined basic interaction, and extracting the unique characteristics of the user from usage data accumulated through the user-customized interaction and updating the user-customized interaction so as to match the unique characteristics of the user; and memory for storing the user-customized ergonomic information and the user-customized interaction.

Here, the unique characteristics of the user may include at least one of unique motion characteristics of the user and unique information provision characteristics of the user.

Here, the processor may generate the user-customized ergonomic information by modifying the basic ergonomic information of the user so as to match at least one of body information and joint rearrangement information input from the user.

Here, the misrecognition may occur in a basic user interface for performing the predefined basic interaction.

Here, the user-customized interaction may be performed through a user-customized interface, which modifies a part of the basic user interface in which the misrecognition occurs so as to match the physical characteristics of the user.

Here, the user-customized ergonomic information may be updated when the user evaluation information is input.

Here, the basic ergonomic information may include at least one of the position of a joint in each body part of the user, the angle thereof, the direction in which the joint moves, and the speed at which the joint moves.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows a system for providing a user-customized augmented-reality service according to an embodiment of the present invention;

FIG. 2 is a flowchart that shows a method for providing a user-customized augmented-reality service according to an embodiment of the present invention;

FIG. 3 is a view that shows an example of the process of generating user-customized ergonomic information according to the present invention;

FIG. 4 is a view that shows an example of the process of defining user-customized interaction according to the present invention;

FIG. 5 is a flowchart that shows an example of the process of updating user-customized interaction according to the present invention;

FIG. 6 is a view that shows an example of the process of updating user-customized interaction based on user evaluation according to the present invention;

FIG. 7 is a flowchart that specifically shows a method for providing a user-customized augmented-reality service according to an embodiment of the present invention;

FIG. 8 is a block diagram that shows an apparatus for providing a user-customized augmented-reality service according to an embodiment of the present invention; and

FIG. 9 is a flowchart that shows an example in which a user-customized interface is automatically updated according to the present invention.

### DESCRIPTION OF THE PREFERRED EMBODIMENTS

The present invention will be described in detail below with reference to the accompanying drawings. Repeated descriptions and descriptions of known functions and configurations which have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

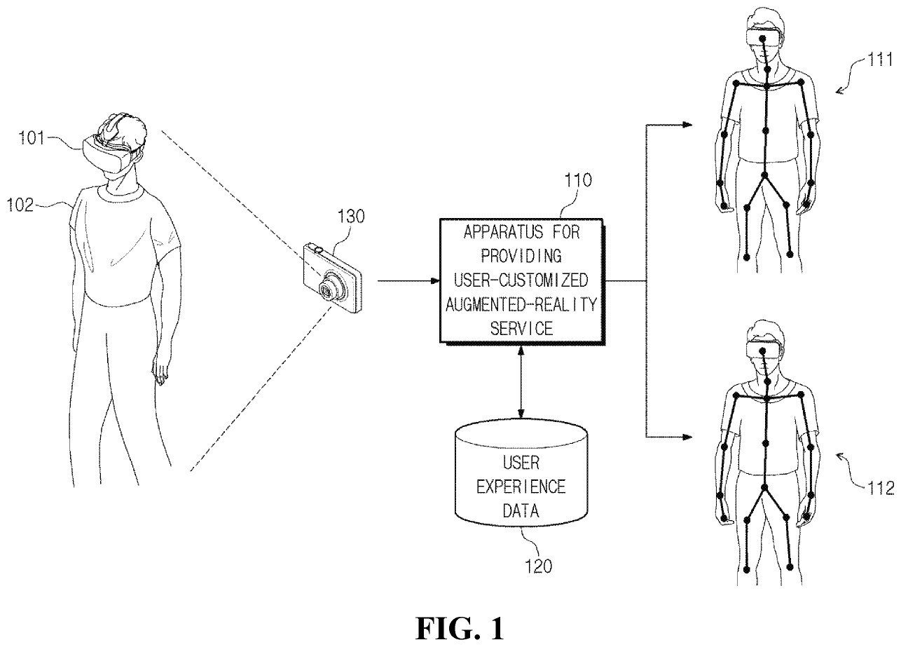

FIG. 1 is a view that shows a system for providing a user-customized augmented-reality service according to an embodiment of the present invention.

Referring to FIG. 1, the system for providing a user-customized augmented-reality service according to an embodiment of the present invention may include an apparatus 110 for providing a user-customized augmented-reality service and a user 102 who is using the augmented-reality service while wearing an AR device 101.

The apparatus 110 for providing a user-customized augmented-reality service 110 may sense the body of the user 102 who is using the augmented-reality service, thereby extracting the basic ergonomic information 111 of the user.

For example, the body of the user 102 who is using the augmented-reality service while wearing the AR device 101 is captured using a sensor 130 equipped with a camera, as shown in FIG. 1, whereby the basic ergonomic information 111 of the user may be extracted.

Here, the basic ergonomic information 111 of the user may include at least one of the position of a joint in each body part of the user 102, the angle thereof, the direction in which the joint is moving, and the speed at which the joint is moving.

Also, the apparatus 110 for providing a user-customized augmented-reality service may modify the basic ergonomic information 111 of the user based on at least one of misrecognition occurring in predefined basic interaction and user evaluation information, thereby generating user-customized ergonomic information 112.

Here, the basic ergonomic information 111 is modified so as to match at least one of the body information and the joint rearrangement information input from the user 102, whereby user-customized ergonomic information 112 may be generated.

Here, misrecognition may occur in a basic user interface for performing the predefined basic interaction.

Here, the user-customized ergonomic information 112 may be updated when user evaluation information is input.

Also, the apparatus 110 for providing a user-customized augmented-reality service may detect the physical characteristics of the user by comparing the basic ergonomic information 111 of the user with the user-customized ergonomic information 112 and reflect the physical characteristics of the user in the predefined basic interaction, thereby defining user-customized interaction.

Here, the user-customized interaction may be performed through a user-customized interface, which is generated in such a way that a part of the basic user interface in which misrecognition has occurred is modified so as to match the physical characteristics of the user.

Also, the apparatus 110 for providing a user-customized augmented-reality service may extract the unique characteristics of the user from usage data, which is accumulated when the user-customized interaction is performed, and may update the user-customized interaction so as to match the unique characteristics of the user.

Here, the unique characteristics of the user may include at least one of the unique motion characteristics of the user and the unique information provision characteristics of the user.

The above-described system for providing a user-customized augmented-reality service may meet the needs of customers without inconvenience or problems in terms of user experience (UX) and provide a simple and elegant augmented-reality service.

Also, a user may be provided with information and may interact more naturally and easily in an augmented-reality environment.

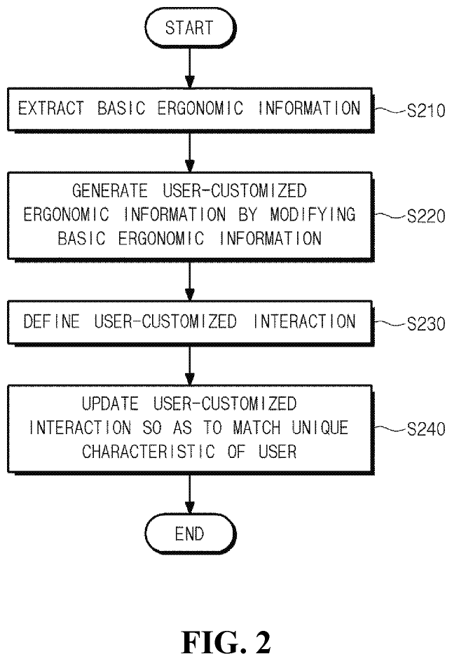

FIG. 2 is a flowchart that shows a method for providing a user-customized augmented-reality service according to an embodiment of the present invention.

Referring to FIG. 2, in the method for providing a user-customized augmented-reality service according to the present invention, the body of the user who is using the augmented-reality service is sensed, whereby the basic ergonomic information of the user is extracted at step S210.

Here, the user who is using the augmented-reality service is sensed using any of various types of ergonomic information extraction sensors, which are capable of sensing the body of the user, and then the sensing data is obtained from the sensors, whereby the basic ergonomic information of the user may be extracted.

Here, the user who is using the augmented-reality service may be the user who is interacting with the information provided in the augmented-reality service.

For example, the method for providing a user-customized augmented-reality service according to an embodiment of the present invention may provide a user with various augmented-reality tasks through an AR device in order to extract various kinds of basic ergonomic information pertaining to the user, and may sense the body of the user who is performing the tasks, whereby various kinds of data, from which the basic ergonomic information is to be extracted, may be obtained. That is, tasks, such as sitting down and standing up, walking, picking up and dropping an object, shaking the head from side to side, and the like, are assigned to the user, whereby the user may be induced to take various actions.

Here, the basic ergonomic information of the user may include various types of detailed physical information.

Here, the basic ergonomic information of the user may include at least one of the position of a joint in each body part of the user, the angle thereof, the direction in which the joint is moving, and the speed at which the joint is moving.

For example, N or more joints are detected in the body of the user based on the sensing data obtained from various types of ergonomic information extraction sensors, and the 3D motion of the body may be extracted based on the N or more joints. Here, joint-mapping information pertaining to the body of the user, which is included in the basic ergonomic information of the user, may be generated without considering the physical characteristics of the user. That is, the joint-mapping information may be originally extracted basic ergonomic information, rather than ergonomic information customized to the user.

Also, in the method for providing a user-customized augmented-reality service according to an embodiment of the present invention, user-customized ergonomic information is generated at step S220 by modifying the basic ergonomic information of the user based on at least one of misrecognition occurring in predefined basic interaction and user evaluation information.

Here, the basic ergonomic information of the user may be universal data that is applicable not only to the user who is using the augmented-reality service but also to other users. Therefore, the basic ergonomic information is advantageous in that it is applicable to different users, but may cause an interaction error in the augmented-reality service because it is based on rough human body information.

For example, when an augmented-reality service is provided based on ergonomic information in which the physical characteristics of the user are not taken into account, the motion of the user may be incorrectly recognized, whereby it is likely to perform undesired interaction or provide incorrect information. These problems may also be caused when a specific action is taken or the motion of the user is slightly changed.

In order to solve the above-mentioned problems and to detect the unique motion characteristics of the user when an augmented-reality service is provided, the present invention additionally generates and uses user-customized ergonomic information.

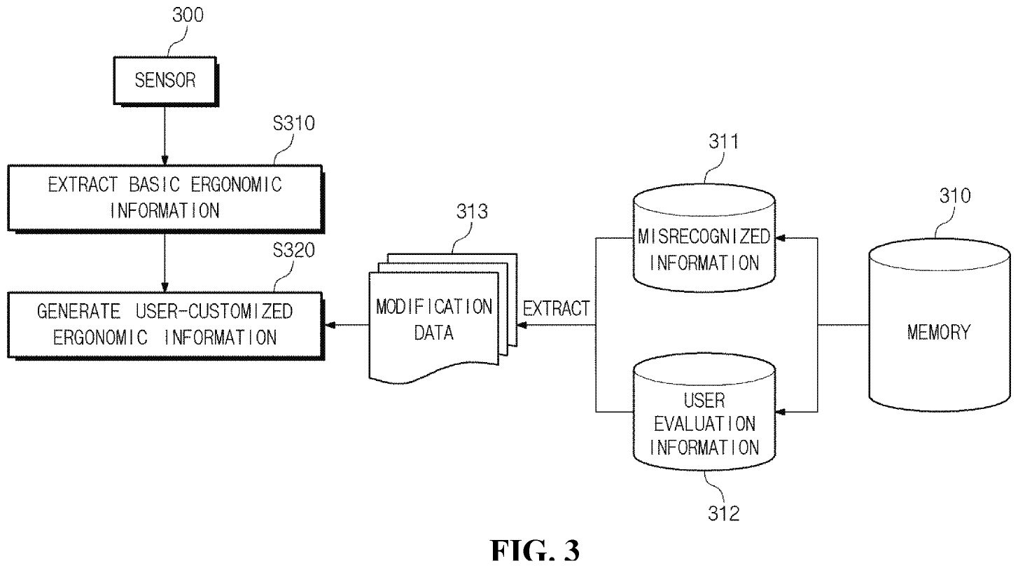

For example, describing the process of generating user-customized ergonomic information with reference to FIG. 3, the basic ergonomic information of the user may be extracted at step S310 based on information about the body of the user sensed by a sensor 300.

Then, when the user uses the augmented-reality service, the user may perform the predefined basic interaction, which is based on the basic ergonomic information, and information about the performance may be accumulated and stored in the memory 310 of the apparatus for providing an augmented-reality service.

Then, misrecognized information 311 or user evaluation information 312 may be obtained from the data accumulated in the memory 310.

Here, misrecognition may occur in a basic user interface for performing the predefined basic interaction. That is, error information or misrecognized information, which is generated while the user is performing the predefined basic interaction using the basic interface provided in the augmented-reality service, may be stored in the memory 310.

Here, the misrecognized information may include not only a simple interaction error but also data about inconvenience that the user experiences when the user uses the augmented-reality service.

Here, the user evaluation information may be obtained in such a way that the user inputs what the user feels when using the service. The user evaluation information may be the means for reflecting the user's satisfaction or the user's opinion about the usability. The user evaluation information may be obtained through an interface in the form of a simple survey provided after the provision of the augmented-reality service finishes. Alternatively, it may be obtained in such a way that the user pushes a few user review buttons before the user finishes using the apparatus for providing an augmented-reality service.

Here, the user evaluation information may or may not be input depending on the intention of the user, but when the user evaluation information is input, the input information may be used to modify the basic ergonomic information.

Accordingly, modification data 313 for modifying the basic ergonomic information of the user may be obtained based on the misrecognized information 311 and the user evaluation information 312.

That is, modification data 313 that is more closely customized to the user may be extracted from the user experience information that is accumulated in the memory 310 when the user actually uses the augmented-reality service and the usability information input by the user.

The basic ergonomic information is modified based on the extracted modification data 313, whereby user-customized ergonomic information may be generated at step S320.

Here, the basic ergonomic information is modified so as to match at least one of the body information and joint rearrangement information input from the user, whereby user-customized ergonomic information may be generated.

For example, skeleton information, including joint information corresponding to the basic ergonomic information of the user, is shown to the user who finishes using the augmented-reality service, and the user may be allowed to rearrange the position of the joint that is suspected to be the cause of the misrecognition.

In another example, when an incorrect interaction result or incorrect information attributable to misrecognition is provided or when a user evaluation result includes inconvenience experienced by the user, the motion related thereto may be detected, and the cause thereof may be shown to the user. Then, the user may actively modify the cause thereof. That is, the skeleton information resulting from the corresponding motion is shown to the user, and the user may determine which joint is incorrectly mapped and rearrange the joint in the skeleton information so as to match his or her motion.

Here, the user-customized ergonomic information may be updated when the user evaluation information is input.

For example, although user-customized ergonomic information customized to a certain user is generated, the user may feel inconvenience and input user evaluation thereabout. In this case, the part required to be additionally modified is found and modified, whereby the user-customized ergonomic information may be updated.

Here, the number of times the user-customized ergonomic information is updated and the time at which the user-customized ergonomic information is updated are not limited to a specific number or a specific time.

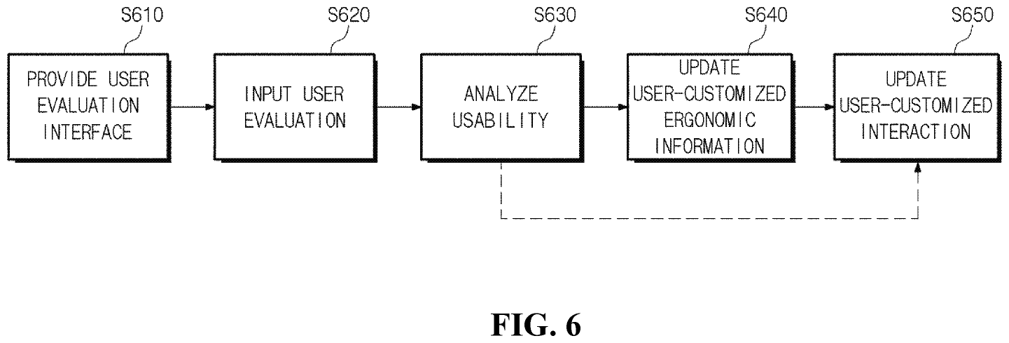

For example, referring to FIG. 6, a separate user evaluation interface may be provided to the user who finishes using the augmented-reality service at step S610. Then, when the user inputs evaluation through the user evaluation interface at step S620, the usability of the currently defined user-customized interaction may be analyzed at step S630 through the input user evaluation. Then, the user-customized ergonomic information may be updated depending on the usability analysis result at step S640, and the user-customized interaction may also be updated based on the updated user-customized ergonomic information at step S650.

Also, in the method for providing a user-customized augmented-reality service according to an embodiment of the present invention, the physical characteristics of the user are detected by comparing the basic ergonomic information of the user with the user-customized ergonomic information, and user-customized interaction is defined at step S230 by reflecting the physical characteristics of the user in the predefined basic interaction.

That is, the present invention may provide an augmented-reality service in which user-customized interaction is defined such that a user makes a motion that feels more natural to the user, rather than inducing the user to make a motion corresponding to the predefined basic interaction.

The existing devices for providing an augmented-reality service employ a passive training method in which a user who first uses the augmented-reality service experiences the use of the device by playing a game or performing a task, thereby learning to use the device.

For example, the user who is wearing an AR device synchronizes his or her motion to the motion of the interface provided through the AR device while performing the task displayed via the AR device, thereby learning how to use the device.

Most augmented-reality service provision devices developed to date may provide adequate interaction through a unidirectional interface without complex interaction with a user. However, because augmented-reality interfaces are expected to become more diverse and because a single interface may employ various interaction methods, it will be difficult for a user to learn to use the augmented-reality service provision device using only a passive training method, which may result in inconvenience in the use thereof.

Therefore, the present invention intends to provide an active training method in order to enable a user to easily learn to use an interface according to the physical characteristics of the user.

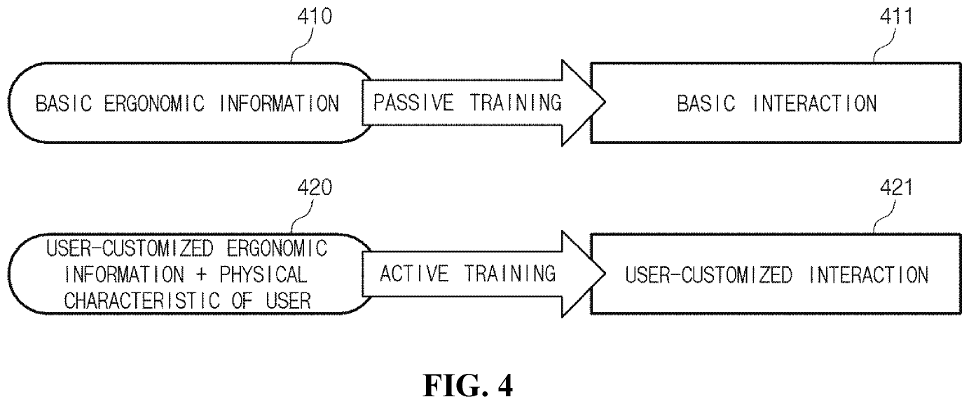

For example, referring to FIG. 4, the apparatus for providing a user-customized augmented-reality service according to the present invention may define basic interaction 411 by performing a passive training method based on the basic ergonomic information 410.

Then, user-customized interaction 421 may be defined by performing an active training method based on the physical characteristics of the user and the user-customized ergonomic information 420, which is generated based on the misrecognition occurring in the basic interaction 411 and the user evaluation information.

For example, it may be assumed that an error, frequently occurring in the basic interaction 411, relates to an action using the tiny movement of a finger. In this case, if it is confirmed that the error frequently occurs when the user bends his or her little finger and if it is confirmed through the user-customized ergonomic information or the physical characteristics of the user that the top knuckle of the little finger of the user is shorter than that of other users, the basic interaction is modified so as to be customized to the user, whereby the user-customized interaction 421 may be defined.

Here, the user-customized interaction may be performed through the user-customized interface, which is generated in such a way that a part of the basic user interface, in which misrecognition has occurred, is modified so as to match the physical characteristics of the user.

Therefore, the user-customized interface may be provided after it is modified into a form that the user can easily use, and may be updated when the user-customized interaction is updated.

Also, in the method for providing a user-customized augmented-reality service according to an embodiment of the present invention, the unique characteristics of the user are extracted from usage data, which is accumulated when the user-customized interaction is performed, and the user-customized interaction is updated so as to match the unique characteristics of the user at step S240.

That is, the present invention continually updates user-customized interaction based on the accumulated usage data, whereby an augmented-reality service that becomes easier to use over time may be provided.

Here, the unique characteristics of the user may include at least one of the unique motion characteristics of the user and the unique information provision characteristics of the user.

Accordingly, a usual habit found in the motion of the user or the pattern of using information when the user uses the augmented-reality service is analyzed and reflected in the interaction in the augmented-reality service, whereby more convenient service may be provided to the user.

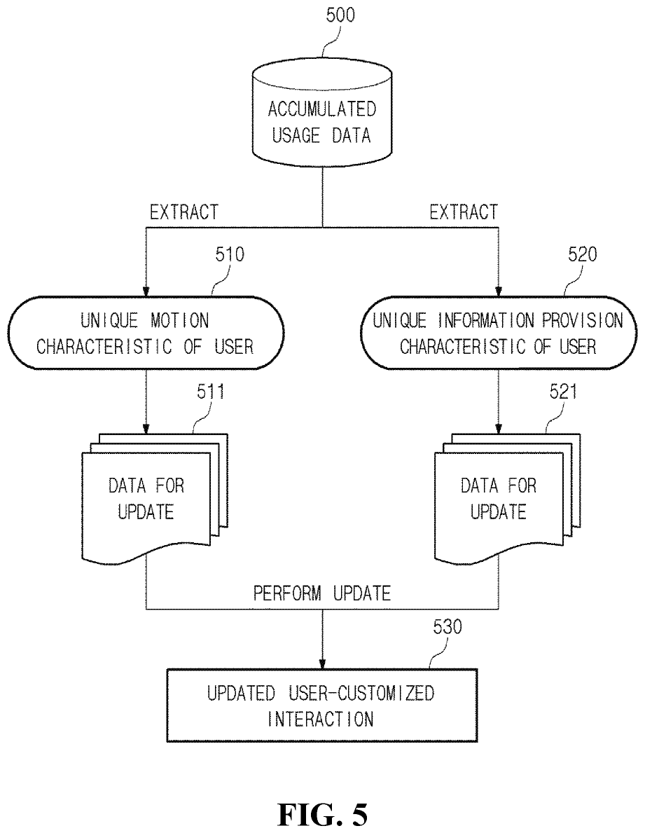

For example, referring to FIG. 5, the unique motion characteristics 510 of the user and the unique information provision characteristics 520 of the user may be extracted from the usage data 500 accumulated through the user-customized interaction.

Here, when the user uses the augmented-reality service through the user-customized interaction, the user may repeatedly take the same action or input similar motion by slightly changing the interaction speed or form because the user feels that his or her motion is not correctly recognized. In this case, the present invention accumulates data thereabout and analyzes the data, thereby detecting the tendency of the motion of the user or the pattern of providing information.

Then, data 511 and 521 for updating the user-customized interaction is generated based on the detected information, and the user-customized interaction 530, which is updated by applying the data 511 and 521 thereto, may be provided.

In another example, when it becomes common for people to wear AR devices during their daily lives or when walking because of the popularization of an augmented-reality service provision apparatus in the future, it is necessary to consider the range of motion for interaction and how the user who is performing the interaction looks. If the user looks funny or weird because the user makes a big motion for the interaction, this may make other people uncomfortable or upset. Therefore, the present invention may update the user-customized interaction such that the user is able to use a simple and graceful motion and gestures when the user uses the augmented-reality service provision apparatus.

In another example, the user-customized interaction may be updated in such a way that the color of the augmented-reality information to be provided is made vivid or in such a way that the augmented-reality information is provided twice in a specific position, at which the user may easily check the augmented-reality information, in consideration of the motion characteristics, such as the eyesight of the user or the orientation of the head of the user. If a usability analysis result saying that it would be good to repeatedly provide the user with augmented-reality information three or more times is input through the user evaluation, the user-customized interaction may be updated so as to repeatedly provide the requested information or information similar thereto three or more times.

Also, although not illustrated in FIG. 2, in the method for providing a user-customized augmented-reality service according to an embodiment of the present invention, various kinds of information generated during the above-described process of providing a user-customized augmented-reality service according to an embodiment of the present invention may be stored in a separate storage module.

Through the above-described method for providing a user-customized augmented-reality service, an augmented-reality service that provides user-centered information and interaction is provided, whereby awareness, usability, and improved user customization may be provided to users who use the augmented-reality service.

Also, an augmented-reality service that enables a user to look more natural and graceful may be provided using user experience information.

Also, an augmented-reality service in which interaction is provided in accordance with the physical characteristics or motion of a user may be provided.

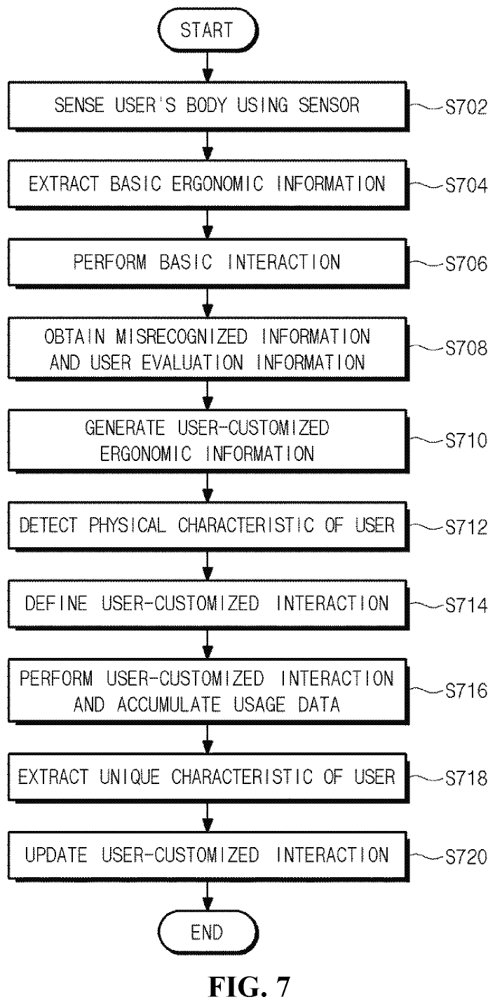

FIG. 7 is a flowchart that specifically shows a method for providing a user-customized augmented-reality service according to an embodiment of the present invention.

Referring to FIG. 7, in the method for providing a user-customized augmented-reality service according to an embodiment of the present invention, the body of the user who is using an augmented-reality service is sensed at step S702 using various types of ergonomic information extraction sensors.

Then, the basic ergonomic information of the user is extracted from the sensing data obtained from the sensors at step S704, and the user may perform predefined basic interaction through the augmented-reality service at step S706.

Then, at least one of misrecognition occurring in the predefined basic interaction and user evaluation information is obtained at step S708, and the basic ergonomic information of the user is modified based on at least one of the obtained misrecognition and user evaluation information, whereby user-customized ergonomic information may be generated at step S710.

Then, the physical characteristics of the user are detected at step S712 by comparing the basic ergonomic information of the user with the user-customized ergonomic information, and user-customized interaction may be defined at step S714 by reflecting the physical characteristics of the user in the predefined basic interaction.

Then, when the user performs the user-customized interaction through the augmented-reality service, usage data generated therefrom may be accumulated and stored at step S716.

Then, the unique characteristics of the user may be extracted from the accumulated usage data at step S718, and the user-customized interaction may be updated at step S720 so as to match the extracted unique characteristics of the user.

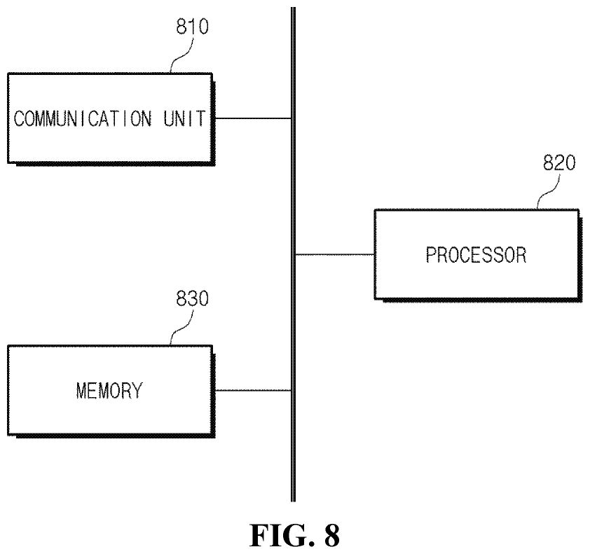

FIG. 8 is a block diagram that shows an apparatus for providing a user-customized augmented-reality service according to an embodiment of the present invention.

Referring to FIG. 8, the apparatus for providing a user-customized augmented-reality service according to an embodiment of the present invention includes a communication unit 810, a processor 820 and memory 830.

The communication unit 810 may serve to transmit and receive information that is necessary in order to provide a user-customized augmented-reality service through a communication network. Particularly, the communication unit 810 according to an embodiment of the present invention may receive the data obtained by sensing the body information of a user from a sensor, or may transmit the data that is updated in order to provide user-customized interaction in the AR device.

The processor 820 senses the body of the user who is using the augmented-reality service, thereby extracting the basic ergonomic information of the user.

Here, the user who is using the augmented-reality service is sensed using any of various types of ergonomic information extraction sensors, which are capable of sensing the body of the user, and the sensing data is obtained from the sensors, whereby the basic ergonomic information of the user may be extracted.

Here, the user who is using the augmented-reality service may be the user who is interacting with the information provided in the augmented-reality service.

For example, the method for providing a user-customized augmented-reality service according to an embodiment of the present invention may provide a user with various augmented-reality tasks through an AR device in order to extract various kinds of basic ergonomic information pertaining to the user, and may sense the body of the user who is performing the tasks, whereby various kinds of data, from which the basic ergonomic information of the user is to be extracted, may be obtained. That is, tasks, such as sitting down and standing up, walking, picking up and dropping an object, shaking the head from side to side, and the like, are assigned to the user, whereby the user may be induced to take various actions.

Here, the basic ergonomic information of the user may include various types of detailed physical information.

Here, the basic ergonomic information of the user may include at least one of the position of a joint in each body part of the user, the angle thereof, the direction in which the joint is moving, and the speed at which the joint is moving.

For example, N or more joints are detected in the body of the user based on the sensing data obtained from various types of ergonomic information extraction sensors, and the 3D motion of the body may be extracted based on the N or more joints. Here, joint-mapping information pertaining to the body of the user, which is included in the basic ergonomic information of the user, may be generated without considering the physical characteristics of the user. That is, the joint-mapping information may be originally extracted basic ergonomic information, rather than ergonomic information customized to the user.

Also, the processor 820 generates user-customized ergonomic information by modifying the basic ergonomic information of the user based on at least one of misrecognition occurring in predefined basic interaction and user evaluation information.

Here, the basic ergonomic information of the user may be universal data that is applicable not only to the user who is using the augmented-reality service but also to other users. Therefore, the basic ergonomic information is advantageous in that it is applicable to different users, but may cause an interaction error in the augmented-reality service because it is based on rough human body information.

For example, when an augmented-reality service is provided based on ergonomic information in which the physical characteristics of the user are not taken into account, the motion of the user may be incorrectly recognized, whereby it is likely to perform undesired interaction or provide incorrect information. These problems may also be caused when a specific action is taken or the motion of the user is slightly changed.

In order to solve the above-mentioned problems and to detect the unique motion characteristics of the user when an augmented-reality service is provided, the present invention additionally generates and uses user-customized ergonomic information.

For example, describing the process of generating user-customized ergonomic information with reference to FIG. 3, the basic ergonomic information of the user may be extracted at step S310 based on information about the body of the user sensed by a sensor 300.

Then, when the user uses the augmented-reality service, the user may perform the predefined basic interaction, which is based on the basic ergonomic information, and information about the performance may be accumulated and stored in the memory 310 of the apparatus for providing an augmented-reality service.

Then, misrecognized information 311 or user evaluation information 312 may be obtained from the data accumulated in the memory 310.

Here, misrecognition may occur in a basic user interface for performing the predefined basic interaction. That is, error information or misrecognized information, generated when the user performs the predefined basic interaction using the basic interface provided in the augmented-reality service, may be stored in the memory 310.

Here, the misrecognized information may include not only a simple interaction error but also data about inconvenience that the user experiences when the user uses the augmented-reality service.

Here, the user evaluation information may be obtained in such a way that the user inputs what the user feels when he or she is using the service, and may be the means for reflecting the user's satisfaction or the user's opinion about the usability. Such user evaluation information may be obtained through an interface in the form of a simple survey provided after the provision of the augmented-reality service finishes. Alternatively, it may be obtained in such a way that the user pushes a few user review buttons before the user finishes using the apparatus for providing an augmented-reality service.

Here, the user evaluation information may or may not be input depending on the intention of the user, but when the user evaluation information is input, the input information may be used to modify the basic ergonomic information.

Accordingly, modification data 313 for modifying the basic ergonomic information of the user may be obtained based on the misrecognized information 311 and the user evaluation information 312.

That is, the modification data 313 that is more closely customized to the user may be extracted from the user experience information that is accumulated in the memory 310 when the user actually uses the augmented-reality service and the usability information input by the user.

The basic ergonomic information is modified based on the extracted modification data 313, whereby user-customized ergonomic information may be generated at step S320.

Here, the basic ergonomic information is modified so as to match at least one of the body information and joint rearrangement information input from the user, whereby user-customized ergonomic information may be generated.

For example, skeleton information, which includes joint information corresponding to the basic ergonomic information of the user, is shown to the user who finishes using the augmented-reality service, and the user may be allowed to rearrange the position of the joint that is suspected to be the cause of the misrecognition.

In another example, when an incorrect interaction result or incorrect information attributable to misrecognition is provided or when a user evaluation result includes inconvenience experienced by the user, the motion related thereto may be detected, and the cause thereof may be shown to the user. Then, the user may actively modify the cause thereof. That is, the skeleton information resulting from the corresponding motion is shown to the user, and the user may determine which joint is incorrectly mapped and rearrange the joint in the skeleton information so as to match his or her motion.

Here, the user-customized ergonomic information may be updated when the user evaluation information is input.

For example, although ergonomic information customized to a certain user is generated, the user may feel inconvenience and input user evaluation thereabout. In this case, the part that is required to be additionally modified is found and modified, whereby the user-customized ergonomic information may be updated.

Here, the number of times the user-customized ergonomic information is updated and the time at which the user-customized ergonomic information is updated are not limited to a specific number or a specific time.

For example, referring to FIG. 6, a separate user evaluation interface may be provided to the user who finishes using the augmented-reality service at step S610. Then, when the user inputs evaluation through the user evaluation interface at step S620, the usability of the currently defined user-customized interaction may be analyzed at step S630 through the input user evaluation. Then, the user-customized ergonomic information may be updated depending on the usability analysis result at step S640, and the user-customized interaction may also be updated based on the updated user-customized ergonomic information at step S650.

Also, the processor 820 detects the physical characteristics of the user by comparing the basic ergonomic information of the user with the user-customized ergonomic information and defines user-customized interaction by reflecting the physical characteristics of the user in the predefined basic interaction.

That is, the present invention may provide an augmented-reality service in which user-customized interaction is defined such that a user makes a motion that feels more natural to the user, rather than inducing the user to make a motion corresponding to the predefined basic interaction.

The existing devices for providing an augmented-reality service employ a passive training method in which a user who first uses the augmented-reality service experiences the use of the device by playing a game or performing a task, thereby learning how to use the device.

For example, the user who is wearing an AR device synchronizes his or her motion to the motion of the interface provided through the AR device while performing the task displayed via the AR device, thereby learning to use the device.

Most augmented-reality service provision devices developed to date may provide adequate interaction through a unidirectional interface without complex interaction with a user. However, because augmented-reality interfaces are expected to become more diverse and because a single interface may employ various interaction methods, it will be difficult for a user to learn to use the augmented-reality service provision device using only a passive training method, which may result in inconvenience in the use thereof.

Therefore, the present invention intends to provide an active training method in order to enable a user to easily learn to use an interface according to the physical characteristics of the user.

For example, referring to FIG. 4, the apparatus for providing a user-customized augmented-reality service according to the present invention may define basic interaction 411 by performing a passive training method based on the basic ergonomic information 410.

Then, user-customized interaction 421 may be defined by performing an active training method based on the physical characteristics of the user and the user-customized ergonomic information 420, which is generated based on the misrecognition occurring in the basic interaction 411 and the user evaluation information.

For example, it may be assumed that an error frequently occurring in the basic interaction 411 relates to an action using the tiny movement of a finger. In this case, if it is confirmed that the error frequently occurs when the user bends his or her little finger and if it is confirmed through the user-customized ergonomic information or the physical characteristics of the user that the top knuckle of the little finger of the user is shorter than that of other users, the basic interaction is modified so as to be customized to the user, whereby the user-customized interaction 421 may be defined.

Here, the user-customized interaction may be performed through the user-customized interface, which is generated in such a way that the part of the basic user interface in which misrecognition has occurred is modified so as to match the physical characteristics of the user.

Therefore, the user-customized interface may be provided after it is modified into a form that the user can easily use, and may be updated when the user-customized interaction is updated.

Also, the processor 820 extracts the unique characteristics of the user from usage data, which is accumulated through the user-customized interaction, and updates the user-customized interaction so as to match the unique characteristics of the user.

That is, the present invention continually updates the user-customized interaction based on the accumulated usage data, whereby an augmented-reality service that becomes easier to use over time may be provided.

Here, the unique characteristics of the user may include at least one of the unique motion characteristics of the user and the unique information provision characteristics of the user.

Accordingly, a usual habit found in the motion of the user or the pattern of using information when the user uses the augmented-reality service is analyzed and reflected in the interaction in the augmented-reality service, whereby more convenient service may be provided to the user.

For example, referring to FIG. 5, the unique motion characteristics 510 of the user and the unique information provision characteristics 520 of the user may be extracted from the usage data 500 accumulated through the user-customized interaction.

Here, when the user uses the augmented-reality service through the user-customized interaction, the user may repeatedly take the same action or input similar motion by slightly changing the interaction speed or form because the user feels that his or her motion is not correctly recognized. In this case, the present invention accumulates data thereabout and analyzes the data, thereby detecting the tendency of the motion of the user or the pattern of providing information.

Then, data 511 and 521 for updating the user-customized interaction is generated based on the detected information, and a user-customized interaction 530 that is updated by applying the data 511 and 521 thereto may be provided.

In another example, when it becomes common for people to wear AR devices during their daily lives or when walking because of the popularization of an augmented-reality service provision apparatus in the future, it is necessary to consider the range of motion for interaction and how the user who is performing the interaction looks. If the user looks funny or weird because the user makes a big motion for the interaction, this may make other people uncomfortable or upset. Therefore, the present invention may update the user-customized interaction such that the user is able to use a simple and graceful motion and gestures when the user uses the augmented-reality service provision apparatus.

In another example, the user-customized interaction may be updated in such a way that the color of the augmented-reality information to be provided is made vivid or in such a way that the augmented-reality information is provided twice in a specific position, at which the user may easily check the augmented-reality information, in consideration of the motion characteristics, such as the eyesight of the user or the orientation of the head of the user. If a usability analysis result saying that it would be good to repeatedly provide the user with augmented-reality information three or more times is input through the user evaluation, the user-customized interaction may be updated so as to repeatedly provide the requested information or information similar thereto three or more times.

The memory 830 stores the user-customized ergonomic information and the user-customized interaction.

Also, the memory 830 stores various kinds of information generated during the above-described process of providing the user-customized augmented-reality service according to an embodiment of the present invention.

According to an embodiment, the memory 830 may support the functions for providing a user-customized augmented-reality service by being separate from the apparatus for providing a user-customized augmented-reality service. Here, the memory 830 may operate as separate mass storage, and may include a control function for performing operations.

Meanwhile, the apparatus for providing a user-customized augmented-reality service may include memory installed therein, thereby storing information in the apparatus. In an embodiment, the memory is a computer-readable recording medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage.

Using the above-described apparatus for providing a user-customized augmented-reality service, a user may be provided with an augmented-reality service that provides user-centered information and interaction, whereby awareness, usability, and improved user customization may be provided to the user who uses the augmented-reality service.

Also, an augmented-reality service that enables a user to look more natural and graceful may be provided using user experience information.

Also, an augmented-reality service in which interaction is provided in accordance with the physical characteristics or motion of a user may be provided.

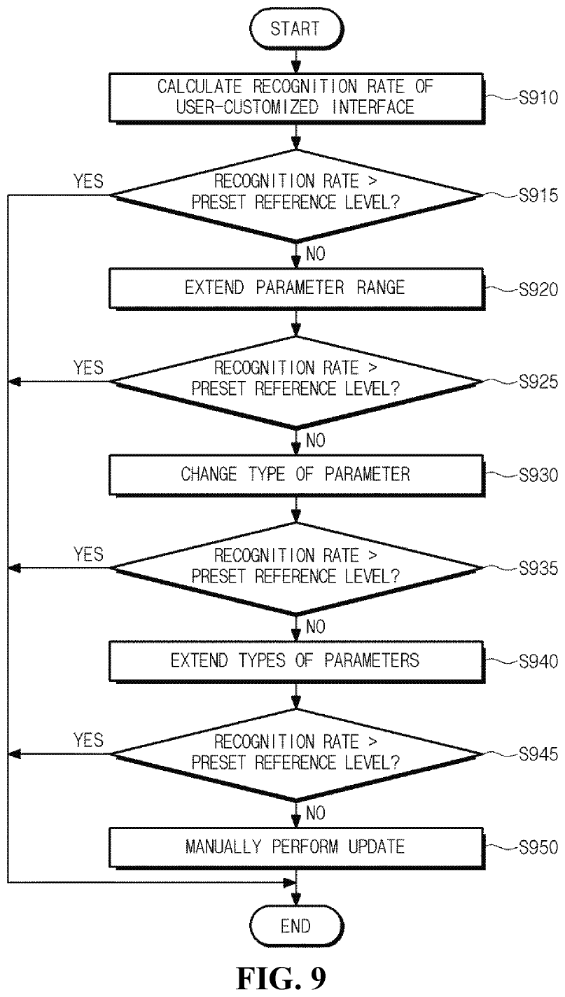

FIG. 9 is a flowchart that shows an example in which a user-customized interface according to the present invention is automatically or manually updated.

First, basic interaction according to an embodiment of the present invention may be defined based on the action taken by a user in an Augmented-Reality (AR) environment. For example, it may be assumed that the user who is using the AR service holds a kettle, which is a virtual object, with his or her hands and pours water from the kettle into a cup, which is a real object. Here, the action taken by the user may be described as the action of precisely holding the handle of the kettle, which is a virtual object, with the actual hand (e.g., right hand) of the user and the action of precisely pouring virtual water, which is constructed based on a physical phenomenon, into the cup, which is a real object held with the other hand (e.g., left hand) of the user.

Here, basic ergonomic information, such as the overall shape of the hands of the user, the three-dimensional coordinates (x, y, z) of the position of the knuckles of the hands, the directional coordinates thereof, and the like, may be extracted. Then, the basic user interaction, such as ‘hold the handle of a kettle’, ‘pour water from a kettle’, and the like, may be defined based on a combination of the extracted pieces of basic ergonomic information.

Using the basic user interaction that is initially defined based on the basic ergonomic information, an augmented-reality service may be provided in the actual AR environment.

Then, the present invention may modify the type or range of human body information to be used for interaction in consideration of the result of the interaction, that is, the recognition rate. Here, whether the factors affecting the recognition rate are factors common to anybody or the unique characteristics of a specific user may be determined. When the factors affecting the recognition rate are determined to be the unique characteristics of the specific user, user-customized interaction may be defined by reflecting the unique characteristics of the user.

For example, when a user is forced to directly or indirectly perform the basic interaction multiple times, if the rate at which the corresponding interaction is recognized is gradually increased, the factors affecting the recognition rate may be determined to be common factors. Here, the user may be directly required to perform the basic interaction through the system, or the system may be configured so as to induce the user to perform the basic interaction in the state in which the user is unaware thereof. When the recognition rate is not increased through such a process, the factors affecting the recognition rate may be regarded as the unique characteristics of the user.

Also, the present invention may extract additional information about the user and more detailed information on the basic ergonomic information, and may incorporate the extracted information in the basic ergonomic information, thereby defining user-customized interaction.

For example, when the basic ergonomic information is extracted based on the action in which a user actually holds a kettle in the real world, it may be assumed that, when the user holds a virtual kettle in the AR environment, the joints of the index finger and the thumb of the user are bent inwards more than when actually holding the kettle in the real world. In this case, in order to represent the shape of the joints of the index finger and the thumb, detailed joint information and various shapes of the hands or the shapes of the fingers are additionally used, whereby user-customized interaction may be defined and the recognition rate may be increased.

Here, the unique characteristics of the user may be characteristics that only the user is aware of, or may be a habit of which the user is unaware. Therefore, the unique characteristics of the user may be detected through the entire sequence of actions that form consecutive interaction events, rather than being found in each of the interaction events. The present invention may redefine the user-customized interaction by modifying the same based on the detected unique characteristics of the user.

For example, when it is necessary to hold the handle of a kettle and pour water from the kettle, a certain user may additionally take an action of placing the index finger on the lid of the kettle in order not to drop the lid even though the kettle and water are a virtual kettle and virtual water. That is, if the user has had the experience of spilling water because the lid of a kettle dropped, the user may have become accustomed to holding the lid of a kettle, and the habit may appear as the unique characteristic of the user in the AR environment. In this case, the action of ‘tipping a kettle and pouring water’, which is defined as the basic interaction, may be divided into ‘holding the lid of a kettle’ and ‘tipping the kettle and pouring water’, and the interaction of ‘tipping a kettle and pouring water’ may be performed by successively performing the two divided actions. Therefore, the present invention may define user-customized interaction by identifying the interaction of each user, in which case a deep-learning-based training method may be used therefor.

However, there is a problem in that it is difficult for the system to automatically analyze and determine the unique characteristics of a user when only the user knows those characteristics, unlike the habit of the user. In this case, the user may intervene in the system and define a user-customized interaction.

For example, if a user wants to use the action defined by himself or herself when pouring water from a kettle, rather than the action generally used by people, or if the user needs to use the action defined by himself or herself because of the physical characteristics of the user, a user-customized interaction may be defined or modified so as to match the action defined by the user.

In the present invention, the system may define or modify a user-customized interaction by observing the interaction of a user and by automatically performing analysis of errors and deep learning, or the user may define an interaction customized to himself or herself and train the system.

Hereinafter, the process of automatically or manually updating a user-customized interface according to the present invention will be described in detail with reference to FIG. 9.

First, a recognition rate may be calculated for each action at step S910 for the user-customized interface for performing user-customized interaction.

Then, whether the calculated recognition rate exceeds a preset reference level is determined at step S915.

Here, the preset reference level may be freely set or changed by a user or a system administrator. For example, assuming that the reference level set for the action of drawing a circle with the left hand is 80%, it may be determined whether the probability that the user-customized interface succeeds in recognizing the corresponding action exceeds 80%.

When it is determined at step S915 that the recognition rate is equal to or less than the preset reference level, a parameter range is extended at step S920.

Here, extension of the parameter range may be extension of the range within which the action is recognized. In the above example, when the parameter range for the action of drawing a circle with the left hand is extended, the range within which the drawn circle is recognized may be extended. Here, depending on the type of action for which the recognition rate must be increased, the parameter range may be reduced.

Then, whether the recognition rate exceeds the preset reference level is determined at step S925, and when it is determined at step S925 that the recognition rate is equal to or less than the preset reference level, the type of parameter is changed at step S930.

That is, when the recognition rate of the user-customized interface is not improved enough to exceed the preset reference level in spite of the extension or reduction of the parameter range, the process of changing the type of parameter may be performed.

For example, if the movement of a finger is tracked at first in order to recognize the action of drawing a circle with a hand, the type of parameter for recognizing the action may be changed so as to track the movement of the wrist, rather than the finger.

Then, whether the recognition rate exceeds the preset reference level is determined at step S935, and when it is determined at step S935 that the recognition rate is equal to or less than the preset reference level, the types of parameters are extended at step S940.

That is, when the recognition rate of the user-customized interface is not improved enough to exceed the preset reference level even though the process of changing the type of parameter is performed, the process of extending the types of parameters may be performed.

For example, if only the movement of a finger is tracked at first in order to recognize the action of drawing a circle with a hand, the types of parameters to be used for recognition may be extended so as to additionally track the movement of the wrist as well as the movement of a finger in order to recognize the action.

Then, whether the recognition rate exceeds the preset reference level is determined at step S945, and when it is determined at step S945 that the recognition rate is equal to or less than the preset reference level, the automatic update is stopped, and the process is changed to perform manual update, whereby the update of the user-customized interface may be performed at step S950.

That is, when the recognition rate is not improved even though extension of the parameter range, the change of the type of parameter, and extension of the types of parameters are performed for the automatic update of the interface, it is determined that it is difficult to improve the recognition rate through the automatic update, and the user-customized interface may be manually updated based on the user input for the corresponding interaction.

For example, when it is difficult to perform automatic update in the system in order to reflect the unique characteristics of a user, which are difficult to extract from the interaction, user-customized interaction based on the unique characteristics is input from the user, whereby the user-customized interface may be updated.

According to the present invention, an augmented-reality service that provides user-centered information and interaction is provided, whereby awareness, usability, and improved user customization may be provided to users who use the augmented-reality service.

Also, the present invention may provide an augmented-reality service that enables a user to look more natural and graceful using user experience information.

Also, the present invention may provide an augmented-reality service in which interaction is provided in accordance with the physical characteristics or motion of a user.

As described above, the apparatus and method for providing a user-customized augmented-reality service according to the present invention are not limitedly applied to the configurations and operations of the above-described embodiments, but all or some of the embodiments may be selectively combined and configured, so that the embodiments may be modified in various ways.

What is claimed is:

1. A method for providing a user-customized augmented-reality service, comprising:
extracting basic ergonomic information of a user by sensing a body of the user who is using an augmented-reality service;
generating user-customized ergonomic information by modifying the basic ergonomic information of the user based on at least one of misrecognition occurring in predefined basic interaction and user evaluation information;
detecting physical characteristics of the user by comparing the basic ergonomic information of the user with the user-customized ergonomic information and defining user-customized interaction by reflecting the physical characteristics of the user in the predefined basic interaction; and
extracting unique characteristics of the user from usage data accumulated through the user-customized interaction and updating the user-customized interaction so as to match the unique characteristics of the user.

2. The method of claim 1, wherein the unique characteristics of the user include at least one of unique motion characteristics of the user and unique information provision characteristics of the user.

3. The method of claim 1, wherein generating the user-customized ergonomic information is configured to generate the user-customized ergonomic information by modifying the basic ergonomic information of the user so as to match at least one of body information and joint rearrangement information input from the user.

4. The method of claim 1, wherein the misrecognition occurs in a basic user interface for performing the predefined basic interaction.

5. The method of claim 4, wherein the user-customized interaction is performed through a user-customized interface, which modifies a part of the basic user interface in which the misrecognition occurs so as to match the physical characteristics of the user.

6. The method of claim 1, wherein the user-customized ergonomic information is updated when the user evaluation information is input.

7. The method of claim 1, wherein the basic ergonomic information of the user includes at least one of a position of a joint in each body part of the user, an angle thereof, a direction in which the joint moves, and a speed at which the joint moves.

8. An apparatus for providing a user-customized augmented-reality service, comprising:
a processor for extracting basic ergonomic information of a user by sensing a body of the user who is using an augmented-reality service, generating user-customized ergonomic information by modifying the basic ergonomic information of the user based on at least one of misrecognition occurring in predefined basic interaction and user evaluation information, detecting physical characteristics of the user by comparing the basic ergonomic information of the user with the user-customized ergonomic information, defining user-customized interaction by reflecting the physical characteristics of the user in the predefined basic interaction, and extracting unique characteristics of the user from usage data accumulated through the user-customized interaction and updating the user-customized interaction so as to match the unique characteristics of the user; and
memory for storing the user-customized ergonomic information and the user-customized interaction.

9. The apparatus of claim 8, wherein the unique characteristics of the user include at least one of unique motion characteristics of the user and unique information provision characteristics of the user.

10. The apparatus of claim 8, wherein the processor generates the user-customized ergonomic information by modifying the basic ergonomic information so as to match at least one of body information and joint rearrangement information input from the user.

11. The apparatus of claim 8, wherein the misrecognition occurs in a basic user interface for performing the predefined basic interaction.

12. The apparatus of claim 11, wherein the user-customized interaction is performed through a user-customized interface, which modifies a part of the basic user interface in which the misrecognition occurs so as to match the physical characteristics of the user.

13. The apparatus of claim 8, wherein the user-customized ergonomic information is updated when the user evaluation information is input.

14. The apparatus of claim 8, wherein the basic ergonomic information includes at least one of a position of a joint in each body part of the user, an angle thereof, a direction in which the joint moves, and a speed at which the joint moves.
